(19) United States
(12) Patent Application Publication
(10) Pub. No.: US 2024/0132685 A1
(43) Pub. Date: Apr. 25, 2024

(54) COATED BALLOON WITH COLOR AND SHIMMERING EFFECTS AND PROCESS OF MAKING THE SAME

(71) Applicant: Seda Bryant, Carmichael, CA (US)

(72) Inventor: Seda Bryant, Carmichael, CA (US)

(21) Appl. No.: 18/381,939

(22) Filed: Oct. 18, 2023

Related U.S. Application Data
(60) Provisional application No. 63/417,806, filed on Oct. 20, 2022.

(51) Int. Cl. C08J 7/04; A63H 27/10; C09D 5/33; C09D 7/61; C09D 11/00; C09D 107/02; C09D 119/02

(52) U.S. Cl. CPC C08J 7/0427; A63H 27/10; C09D 5/004; C09D 7/61; C09D 11/00; C09D 107/02; C09D 119/02; C08J 2307/02

(57) ABSTRACT

A coated balloon with color and shimmering effects and process of making the same. A balloon may be placed on a mould apparatus. A balloon having a rubber ink solution applied to the surface by a dipping process allowing the entire surface of the latex balloon to be coated by the rubber ink solution. The balloon having specific amount of glitter rotationally applied to the entire surface. The latex balloon coated, treated and cured to allow for the ink and glitter to remain affixed to the entire balloon surface in a deflated and expanded state.

### PRIORITY CLAIM

This application is a U.S. Non-Provisional Utility Application entitled, “COATED BALLOON WITH COLOR AND SHIMMERING EFFECTS AND PROCESS OF MAKING THE SAME” which claims priority to co-pending U.S. Provisional Application No. 63/417,806 filed Oct. 20, 2022 entitled, “COATED BALLOON WITH COLOR AND SHIMMERING EFFECTS AND PROCESS OF MAKING THE SAME” the entirety of which is hereby incorporated by reference as if fully set forth herein.

### FIELD

The present invention relates to balloons, and more particularly to the coating of a balloon surface. More specifically, the present invention relates to methods for making balloons having colored and shimmering effects on the surface. The disclosure further relates to applications of rubber ink and glitter to latex balloon surfaces.

### BACKGROUND

Many individuals use balloons for decorations for festive occasions and celebrations. Balloons are used to celebrate holidays, birthdays, anniversaries, promotions, parties and many celebratory occasions. Balloons are also used as decorations when promoting events, shows, concerts, and other occasions. Existing balloons are usually one color and may not provide sufficient decorative appeal for special occasions. While existing decorative balloons may have glitter, confetti, or shimmering effects on the inside, they do not provide the desired effect. As a craft project, one may apply additional effects such as glitter or colors to the outside after inflation, but they do not provide the desired effect of even pattern-like coverage over the total 360 degree surface of the balloon. They are also too heavy to float with helium and common adhesives used in this craft project process may degrade the balloon quality and cause inflated balloons to burst. There are no existing solutions of ready-made uninflated latex balloons with glitter or shimmering effects on the outside, that stays on during and after inflation, with even coverage light enough to float with helium. Additionally, balloons sold with glitter, confetti or shimmering effects on the inside have a dull or subdued look because they are covered by the latex balloon itself, and do not sparkle.

None of these approaches have provided a comprehensive solution that combines the features described in this disclosure. The present invention aims to address the limitations of previous approaches by providing a glitter-modified balloon composition that utilizes a specific combination of rubber ink, emulsion polymer, and glitter to achieve improved adhesion and retention of the glitter on the balloon surface.

Accordingly, there is a need for improved and customizable balloons with glitter combinations. Moreover there is a need for a solution of ready-made latex balloons with color and shimmering effects applied before inflation, that stays on and are light enough to float with helium after inflation.

### SUMMARY

The disclosure provides for a coated balloon with color and shimmering effects and process of making the same.

In general, a coated balloon with color and shimmering effects includes a latex balloon, a rubber ink coating, the rubber ink coating comprising a rubber ink solution, a mould apparatus, an ammonia latex solution, and a deionized water solution.

The invention generally relates to coated balloons and devices which may be manufactured with appropriate materials and processes, and which may be scaled as needed.

In some aspects, the techniques described herein relate to a glitter-modified balloon composition, including: a rubber ink selected from the group consisting of polyisoprene, styrene-butadiene rubber (SBR), polybutadiene, polyisobutylene, and mixtures thereof; an emulsion polymer selected from the group consisting of a synthetic latex, a natural latex, and mixtures thereof; and glitter, the glitter is configured to be retained on the balloon when the composition is deposited on the balloon.

In some aspects, the techniques described herein relate to a glitter-modified balloon composition, wherein the rubber ink is present

In some aspects, the techniques described herein relate to a glitter-modified balloon composition, wherein the rubber ink including, by weight: about 25% natural rubber; about 15% of a solvent; about 5% of a pigment; about 5% of an additive; about 5% of a crosslinking agent; and about 1% of a preservative.

In some aspects, the techniques described herein relate to a glitter-modified balloon composition, wherein the pigment has a particle size in a range of from about 0.34 microns to about 34 microns.

In some aspects, the techniques described herein relate to a glitter-modified balloon composition, wherein the emulsion polymer is present in an amount of from about 10% to about 60% by weight of the composition.

In some aspects, the techniques described herein relate to a glitter-modified balloon composition, wherein the natural latex of the emulsion polymer including, by weight: about 20% natural rubber; about 10% of a solvent; about 5% of a stabilizer; about 5% of an additive; about 5% of a crosslinking agent; and about 1% of a preservative.

In some aspects, the techniques described herein relate to a glitter-modified balloon composition, wherein the glitter is present.

In some aspects, the techniques described herein relate to a glitter-modified balloon composition, wherein the glitter includes a plurality of reflective particles, the glitter selected from the group consisting of metallic foils, polyethylene terephthalate (PET) film, polyvinyl chloride (PVC) film, and mixtures thereof.

In some aspects, the techniques described herein relate to a glitter-modified balloon composition, wherein the plurality of reflective particles of the glitter having a diameter less than 1.5 microns (μm).

In some aspects, the techniques described herein relate to a formulation, including, by weight: a rubber ink, including: about 40% to about 75% rubber base; about 5% to about 7% pigment; and about 5% to about 5% solvent; a latex binder, including: about 15% to about 65% latex; and about 0% to about 5% water; and a reflective material, including: about 1% to about 20% glitter particles.

In some aspects, the techniques described herein relate to a formulation, wherein the rubber ink selected from a vulcanizable synthetic emulsion polymer group consisting of isoprene, butadiene rubber (BR), chloroprene rubber (CR), acrylonitrile-butadiene rubber (NB R), isoprene rubber (IR), styrene-butadiene rubber (SBR), modified styrene-butadiene rubber, carboxy-modified styrene-butadiene rubber (c-SBR), butyl rubber (IIR), and acrylonitrile-styrene-butadiene rubber (NSBR).

In some aspects, the techniques described herein relate to a formulation, wherein the latex binder selected from a vulcanizable synthetic emulsion polymer group consisting of isoprene, butadiene rubber (BR), chloroprene rubber (CR), acrylonitrile-butadiene rubber (NBR), isoprene rubber (IR), styrene-butadiene rubber (SBR), modified styrene-butadiene rubber, carboxy-modified styrene-butadiene rubber (c-SBR), butyl rubber (IIR), and acrylonitrile-styrene-butadiene rubber (NSBR).

In some aspects, the techniques described herein relate to a latex balloon having a film of glitter particles, including: a latex-based rubber ink, the latex-based rubber ink disposed over the latex balloon; a plurality of glitter particles, the plurality of glitter particles disposed over the latex-based rubber ink; and a latex layer, the latex layer disposed over the plurality of glitter particles.

In some aspects, the techniques described herein relate to a latex balloon having a film 16, wherein the latex layer is a solution of raw low ammonia latex and treated deionized water.

In some aspects, the techniques described herein relate to a latex balloon having a film 17, wherein the solution including, by weight: about 10% to about 60% latex; about 25% to about 80% sulfur; about 15% to about 40% zinc diethyl dithiocarbamate; about 15% to about 40% zinc oxide; about 5% to about 29% ammonia; and about 40% to about 90% deionized water.

In some aspects, the techniques described herein relate to a latex balloon having a film 17, wherein the solution including, by weight: about 20% to about 90% latex; about 1% to about 10% Zinc Oxide (ZnO) and Tetramethylthiuram Disulfide (TMTD); about 1% to about 35% ammonia; and about 10% to about 80% deionized water.

In some aspects, the techniques described herein relate to a latex balloon having a film 17, wherein the raw low ammonia latex selected from a vulcanizable synthetic emulsion polymer group consisting of isoprene, butadiene rubber (BR), chloroprene rubber (CR), acrylonitrile-butadiene rubber (NBR), isoprene rubber (IR), styrene-butadiene rubber (SBR), modified styrene-butadiene rubber, carboxy-modified styrene-butadiene rubber (c-SBR), butyl rubber (IIR), and acrylonitrile-styrene-butadiene rubber (NSBR).

In some aspects, the techniques described herein relate to a latex balloon having a film 16, wherein the plurality of glitter particles are present

In some aspects, the techniques described herein relate to a latex balloon having a film 16, wherein the plurality of glitter particles includes a plurality of reflective particles, the plurality of reflective particles selected from the group consisting of metallic foils, polyethylene terephthalate (PET) film, polyvinyl chloride (PVC) film, and mixtures thereof.

In some aspects, the techniques described herein relate to a glitter-modified balloon composition, including: a liquid latex; deionized water; and glitter, the glitter is configured to be retained on the balloon when the composition is deposited on the balloon.

In some aspects, the techniques described herein relate to a glitter-modified balloon composition, wherein liquid latex is present in an amount of from about 10% to about 60% by weight of the composition.

Other objects, features, and advantages of the invention will become apparent from the following detailed description taken in conjunction with the accompanying drawings.

### BRIEF DESCRIPTION OF THE DRAWINGS

Although the characteristic features of the invention will be particularly pointed out in the claims, the invention itself and manners in which it may be made and used may be better understood after a review of the following description, taken in connection with the accompanying drawings, wherein like numeral annotations are provided throughout.

FIGS. 1 and 1A each depict a perspective view of an inflated coated balloon with color and shimmering effects of the present invention.

FIG. 1B illustrates a plurality of uninflated glitter-modified balloons having the formulation disposed on at least a portion of the balloon.

FIG. 2A shows a process of making a coated balloon with color and shimmering effects of the present invention.

FIG. 2B a process of making a coated balloon with color and shimmering effects of the present invention.

FIG. 3 is a block diagram that describes a latex balloon, according to some embodiments of the present disclosure.

FIG. 4 is a block diagram further illustrating the latex balloon from FIG. 3, according to some embodiments of the present disclosure.

FIG. 5 is a block diagram further illustrating the latex balloon from FIG. 3, according to some embodiments of the present disclosure.

FIG. 6 is a block diagram further illustrating the latex balloon from FIG. 3, according to some embodiments of the present disclosure.

FIG. 7 is a block diagram further illustrating the latex balloon from FIG. 3, according to some embodiments of the present disclosure.

### DETAILED DESCRIPTION OF THE INVENTION

Reference is made herein to the attached drawings. Like reference numerals may be used in the drawings to indicate like or similar elements of the description. The figures are intended for representative purposes and should not be considered limiting.

The present disclosure can be understood more readily by reference to the following detailed description of the present disclosure and the examples included therein.

Before the present articles, systems, devices, and/or methods are disclosed and described, it is to be understood that they are not limited to specific implementations unless otherwise specified, or to particular approaches unless otherwise specified, as such can, of course, vary. It is also to be understood that the terminology used herein is for the purpose of describing aspects only and is not intended to be limiting. Although any methods and materials similar or equivalent to those described herein can be used in the practice or testing of the present disclosure, example methods and materials are now described.

All publications mentioned herein are incorporated herein by reference to disclose and describe the methods and/or materials in connection with which the publications are cited.

### Definitions

It is to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this present disclosure belongs. In this specification and in the claims which follow, reference will be made to a number of terms which shall be defined herein.

As used in the specification and the appended claims, the singular forms “a,” “an,” and “the” include plural referents unless the context clearly dictates otherwise. Thus, for example, reference to “an opening” can include two or more openings.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including matters of logic with respect to arrangement of steps or operational flow; plain meaning derived from grammatical organization or punctuation; and the number or type of aspects described in the specification.

Disclosed are the components to be used to manufacture the disclosed devices, systems, and articles of the present disclosure as well as the devices themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the present disclosure. Thus, if there are a variety of additional steps that can be performed it is understood that each of these additional steps can be performed with any specific aspect or combination of aspects of the methods of the present disclosure.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

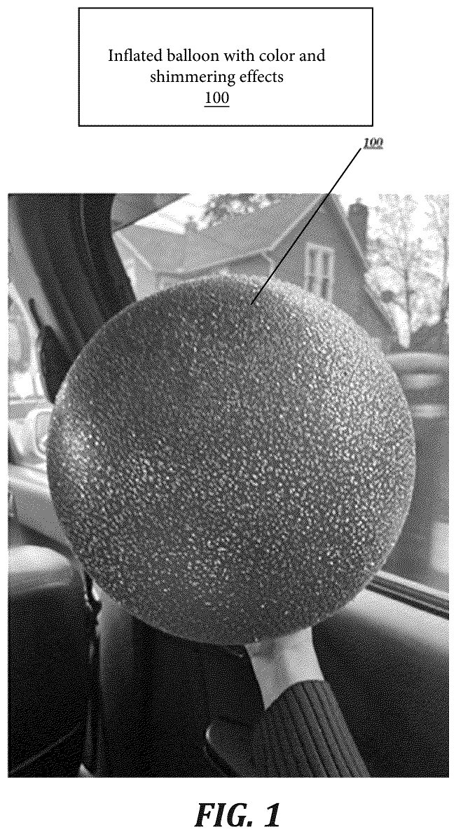

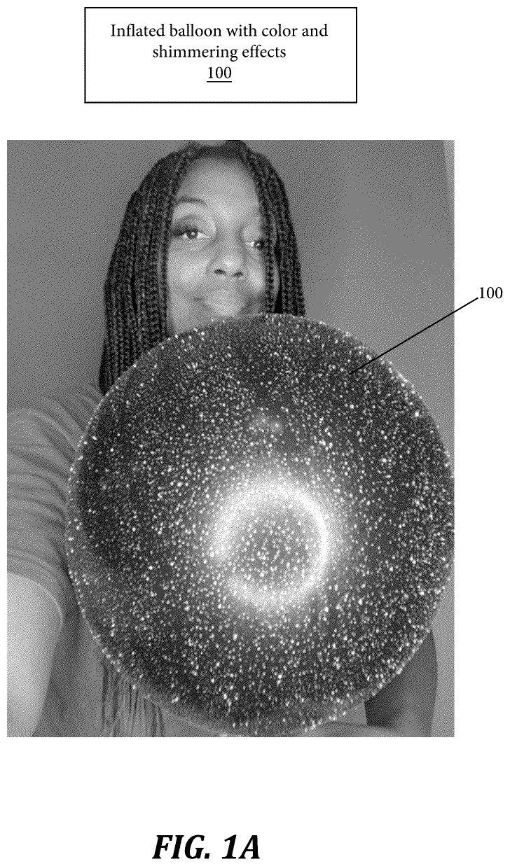

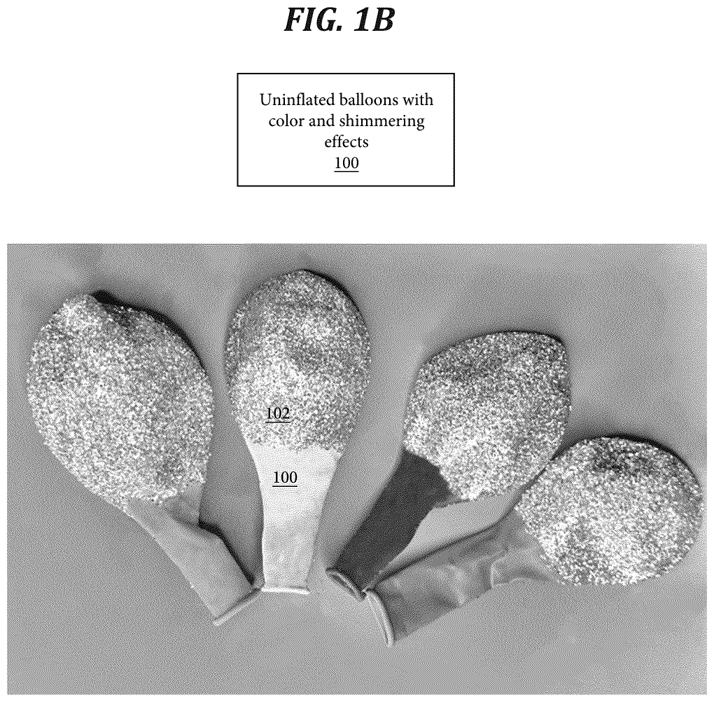

Referring now to FIGS. 1 and 1A, there is shown a perspective view of an inflated coated balloon 100 with color and shimmering effects of the present invention. FIG. 1B illustrates a plurality of uninflated glitter-modified balloons 100 having the formulation 102 disposed on at least a portion of the balloon.

In embodiments, a latex balloon may be placed on a mould apparatus to hold the latex balloon in place. The latex balloon may be uninflated, partially inflated, or partially deflated while on the mould apparatus. In embodiments, the latex balloon would have had a rubber ink solution applied to the surface by a dipping process allowing the entire surface of the latex balloon to be coated by the rubber ink solution. In embodiments, the latex balloon would have a specific measured amount of glitter rotationally applied to the entire surface. In embodiments, the latex balloon would have received a spray coating of raw low ammonia latex. In embodiments, the latex balloon would have been treated with a coating of deionized water acting as a polymer to secure the glitter. In embodiments the latex balloon would have cured overnight or a period of time between eight and twenty-four hours. The coated balloon with color and shimmering effects has a high intensity color surface of rubber ink and glitter affixed to the entire balloon surface.

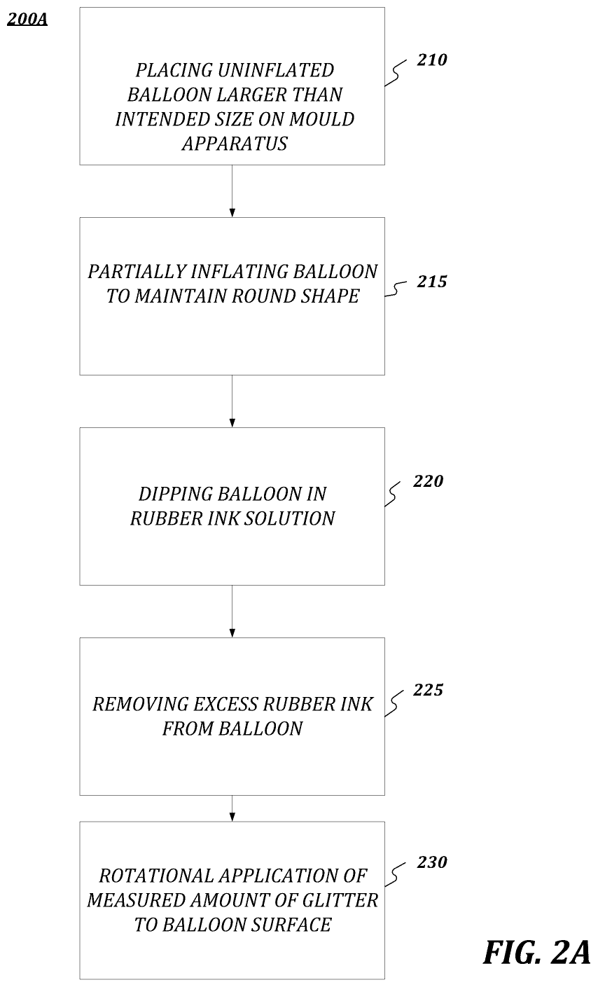

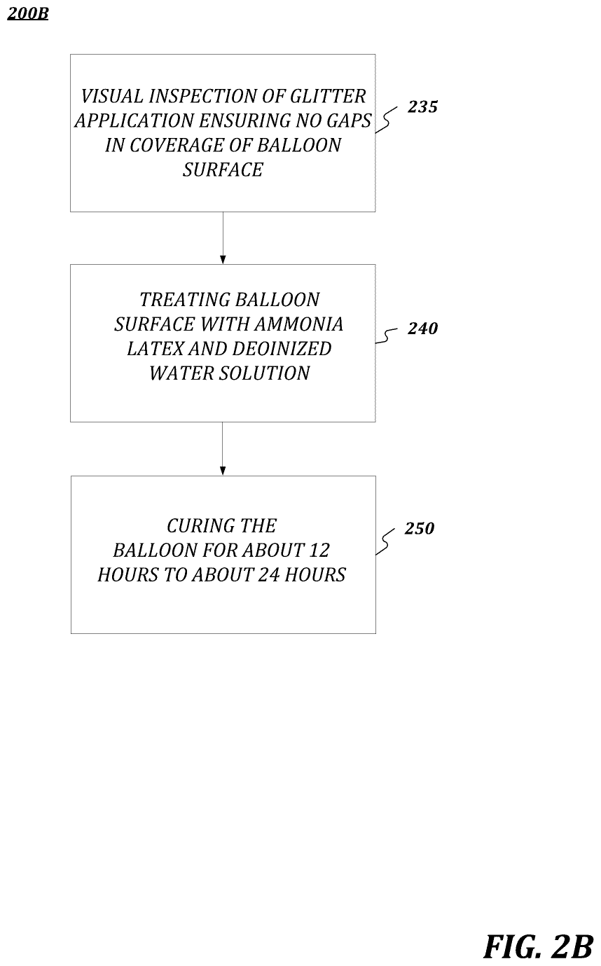

Referring now to FIGS. 2A and 2B, there is shown a process of making a coated balloon with color and shimmering effects of the present invention. In FIG. 2A, 200A, the first step of the process is 210, placing an uninflated balloon on a mould apparatus. The next step, 215 is partially inflating the balloon to maintain an upright position and round shape. Step 220 is dipping the balloon in a rubber ink solution. Step 225 is removing excess rubber ink from the balloon. This may be done by hand or my other effective means including but not limited to the use of a brush, cloth, or other cleaning apparatus. Step 230 is the rotational application of a measured amount of glitter to the balloon surface. This may be done by hand or by other means. Rotational application may be including but not limited to rotating the balloon over a surface whereby the measured amount of glitter has been previously applied to said surface.

Regarding FIG. 2B, 200B, this process continues where 200A left off. The next step 235 is to visually inspect the glitter application on the balloon surface ensuring that there are no gaps in coverage of the balloon surface with the necessary measured amount of glitter. The next step, 240 is treating the balloon surface with an ammonia latex and deionized water solution. This may be done by an application process including but not limited to spraying, pouring, or brush coating the balloon surface. Deionized water acts as a polymer to secure the polyester glitter in place on the balloon surface. The next step, 250 is curing the balloon a period of time ranging from at least twelve hours to as much as twenty-four hours.

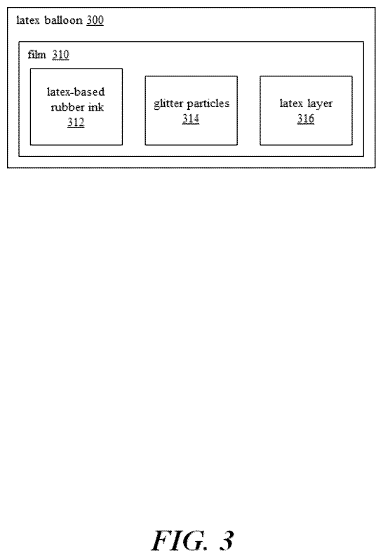

FIG. 3 is a block diagram that describes a latex balloon 300, according to some embodiments of the present disclosure. In some embodiments, the latex balloon 300 may include a film 310 of glitter particles. The film 310 may also include a latex-based rubber ink 312, the latex-based rubber ink 312 disposed over the latex balloon 300. The film 310 may also include a plurality of glitter particles 314, the plurality of glitter particles 314 disposed over the latex-based rubber ink 312. The film 310 may also include a latex layer 316, the latex layer 316 disposed over the plurality of glitter particles 314. In some embodiments, the latex balloon 300 may include a film of glitter particles. The plurality of glitter particles 314 may be present in an amount of from about 5% to about 50% by weight.

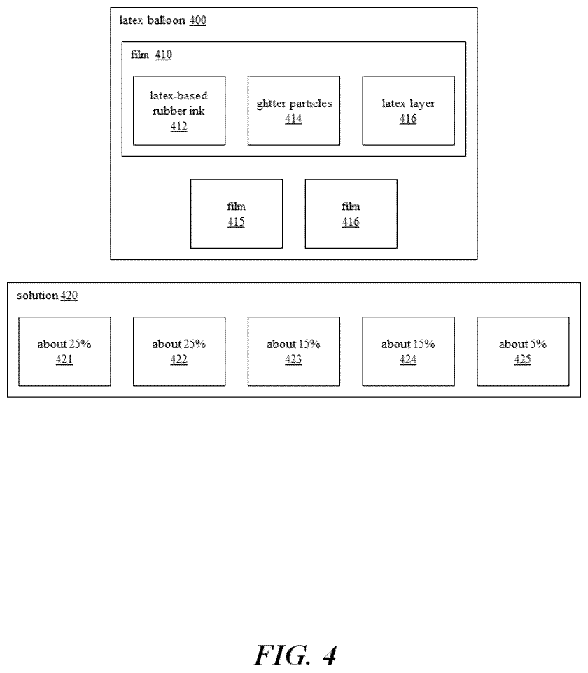

FIG. 4 is a block diagram that further describes the latex balloon 300 from FIG. 3, according to some embodiments of the present disclosure. In some embodiments, the latex balloon 300 may include a film 415 of glitter particles. The latex layer 316 may be a solution 420 of raw low ammonia latex and treated deionized water. In some embodiments, the latex balloon 300 may include a film 416 of glitter particles. The solution 420 may include about 25% 421 to about 90% latex, about 25% 422 to about 60% sulfur, about 15% 423 to about 55% zinc diethyl dithiocarbamate, about 15% 424 to about 50% zinc oxide, and about 5% 425 to about 35% ammonia by weight.

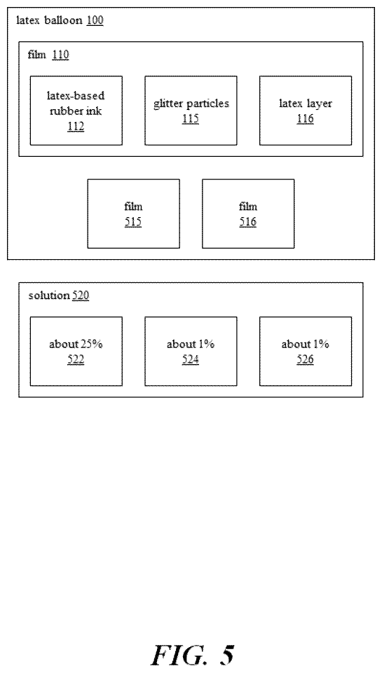

FIG. 5 is a block diagram that further describes the latex balloon 300 from FIG. 3, according to some embodiments of the present disclosure. In some embodiments, the latex balloon 300 may include a film 415 of glitter particles. The latex layer 316 may be a solution 420 of raw low ammonia latex and treated deionized water. In some embodiments, the latex balloon 300 may include a film 516 of glitter particles. The solution 420 may include about 25% 522 to about 90% latex, about 1% 524 to about 10% Zinc Oxide (ZnO) and Tetramethylthiuram Disulfide (TMTD), and about 1% 526 to about 35% ammonia. By weight:

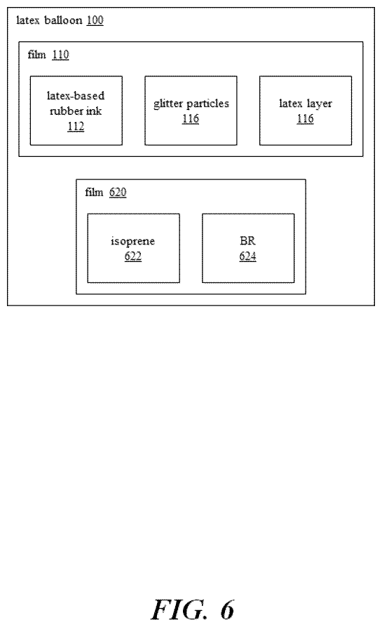

FIG. 6 is a block diagram that further describes the latex balloon 300 from FIG. 3, according to some embodiments of the present disclosure. In some embodiments, the latex balloon 300 may include a film 620 of glitter particles. The film 620 may include isoprene 622. The film 620 may also include butadiene rubber 624 (BR), chloroprene rubber (CR), acrylonitrile-butadiene rubber (NBR), isoprene rubber (IR), styrene-butadiene rubber (SBR), modified styrene-butadiene rubber, carboxy-modified styrene-butadiene rubber (c-SBR), butyl rubber (IIR), and acrylonitrile-styrene-butadiene rubber (NSBR). The raw low ammonia latex selected from a vulcanizable synthetic emulsion polymer group.

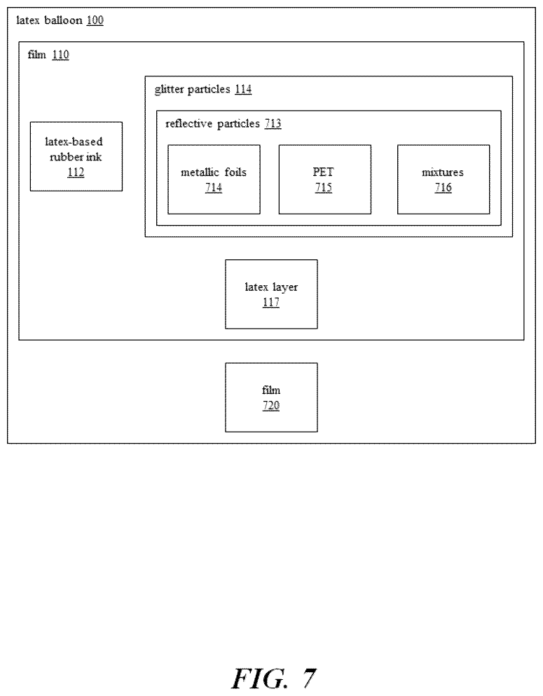

FIG. 7 is a block diagram that further describes the latex balloon 300 from FIG. 3, according to some embodiments of the present disclosure. In some embodiments, the latex balloon 300 may include a film 720 of glitter particles. The plurality of glitter particles 314 may also include a plurality of reflective particles 713, the plurality of reflective particles 713 selected from the group. The plurality of reflective particles 713 may include metallic foils 714 and mixtures 716 thereof. The plurality of reflective particles 713 may also include polyethylene terephthalate 715 (PET) film and polyvinyl chloride (PVC) film.

In embodiments, only latex balloons are used as opposed to foil balloons. This is simply due to the fact that foil balloons are fixed in size in a deflated and inflated state while latex balloons consist of expandable materials. The coated balloon with color and shimmering effects of the present invention is configured such that the glitter stays on the balloon deflated, as the balloon is inflated from one to three inches in size, and expandable up to thirty-six inches in size.

In embodiments, the rubber ink solution is adapted to the desired color application for the coated balloon with color and shimmering effects. In embodiments, the rubber ink solution comprises one or more of the following: a polymer binder, pigments for opacity and coloration, surfactants, and optionally humectants or other drying additives. In the case of a clear ink, no pigment is present. The rubber ink solution may be water based or solvent based. In embodiments, a solvent-based rubber ink comprises a dissolved polymer like natural rubber, one or more isoparaffin solvents, turpentine, and/or Stoddard's solvent which is low-odor mineral spirits. Coloring pigments and rheology modifiers are also present. In embodiments, the rubber ink is formulated with a thixotropic additive to add viscosity at low shear.

In embodiments, water-based rubber inks comprise emulsified polymers, or emulsion-polymerized synthetic polymers (synthetic latexes) or natural rubber latex which is harvested from rubber trees such as Hevea brasiliensis trees or quayule plants. Commercially available NR latex may be classified as high (“HA”) or low ammonia latex (“LATX”). Ammonia and certain stabilizers and curatives are added at the rubber plantation for transit and storage stability to impart resistance to microorganisms and spoilage.

In one or more embodiments, the coated balloon with color and shimmering effects may include the following elements for preparing the rubber ink solution. Both natural and synthetic polymers are available for compounding into rubber ink used in the present invention. The ASTM designations and composition of some common elastomers that can be used are:

TABLE 1

| ASTM designation | Common name | Chemical composition |
|---|---|---|
| NR | Natural rubber | cis-Polyisoprene |
| IR | Synthetic rubber | cis-Polyisoprene |
| BR | Butadiene rubber | cis-Polybutadiene |
| SBR | SBR Poly | (butadiene-styrene) |
| IIR | Butyl rubber Poly | (isobutylene-isoprene)) |

In embodiments, when preparing the coated balloon with color and shimmering effects, liquid latex may be included. The principal class of rubber latex for forming dipped articles such as prophylactics and balloons is natural rubber (NR). The synthetic ink binder polymers for water-based inks are generally emulsion polymers manufactured by well-known emulsion polymerization methods. Synthetic emulsion polymers include synthetic isoprene rubber latex which is polymerized from cis-1,4-polyisoprene monomer. The commercially useful latex compositions in stable latex form include natural rubber latex, synthetic natural rubber latex, and polybutadiene latex, as well as certain polyacrylate emulsion polymers.

In other embodiments, low ammonia latex as well as substances having similar properties and functions may comprise the coated balloon with color and shimmering effects. For these embodiments, vulcanizable synthetic emulsion polymers which could be useful as latex, or as a formulated ink include vulcanizable rubbers include isoprene, butadiene rubber (BR), chloroprene rubber (CR), acrylonitrile-butadiene rubber (NBR), isoprene rubber (IR), styrene-butadiene rubber (SBR), modified styrene-butadiene rubber, carboxy-modified styrene-butadiene rubber (c-SBR), butyl rubber (IIR), and acrylonitrile-styrene-butadiene rubber (NSBR). Those types of rubber may be used alone or in combination.

In embodiments, the rubber ink solution may include but not be limited to the latex marking ink of U.S. Pat. No. 8,618,190B2 to Burik et al. (Bufik hereinafter) or the ink with latex polymers of U.S. Pat. No. 10,072,166 B2 to Ganapathiappan et al. (Ganapathiappan hereinafter). Other synthetic latexes which may be included in the rubber ink solution may include general classes of latex emulsion binders include homopolymers and copolymers from monomers including butadiene, isoprene, unsaturated acrylates, vinyl esters, unsaturated carboxylic acids such as acrylic acid, unsaturated amides, as well as cross linkable monomers, such as N-methylol acrylamide, N-phenylene bismaleimide, and the like. Unsaturated acrylic ester monomers include 2-hydroxyethyl methacrylate, methacrylic acid, n-butyl methacrylic acid, isobutyl methacrylate, ethyl methacrylate, n-propyl acrylate, isopropyl acrylate, pentyl acrylate, n-propyl methacrylate, isopropyl methacrylate, pentyl methacrylate, stearyl methacrylate, lauryl methacrylate, lauryl acrylate, stearyl acrylate, isodecyl methacrylate, isodecyl acrylate, hydropropyl methacrylate, hydropropyl acrylate, t-butylaminoethyl methacrylate, t-butylaminoethyl acrylate, 2-ethylhexyl acrylate and combinations thereof.

Polymerization is conducted in an agitated vessel where initiator is resent and emulsion droplets of unsaturated monomer(s) as micelles are dispersed in deionized water as the continuous medium which is where polymerization takes place. Any of those free-radical emulsion polymerization initiators conventionally employed in the art may be employed in preparing the emulsion lattices used in this invention. Exemplary initiators include ammonium persulfate, sodium persulfate, potassium persulfate, tert-butyl hydroperoxide, and di-tert-butyl cumene. These initiators may be used in conjunction with a reducing agent such as iron salts, amines, ascorbic acids, sodium salts of ascorbates, sodium formaldehyde sulfoxylates, sodium hydrosulfite, sodium thiosulfate, sodium metabisulfite, sodium salts of substituted sulfur-oxy acetic acids, and mixtures thereof. Conventional amounts of initiator and reducing agent can be used in preparing the lattices of this invention. In one embodiment, about 0.05 to about 2.5, and optionally from about 0.1 to about to about 2.0 parts by weight initiator per 100 parts by weight monomer is used.

The latex polymer composition comprises a colloidal dispersion of polymer particles usually less than 1 micron in diameter, such as 0.2-micron average particle size. To keep from coagulating, one or more surfactants are incorporated into the monomer mixture during polymerization in water. Typical surfactants include alkali metal salts of an alkyl sulfosuccinates. Examples of alkali salts of alkyl sulfosuccinates include sodium dihexyl sulfosuccinate, sodium dioctyl sulfosuccinate, sodium octane sulfonate, alkyl phenol ethoxylates, fatty alcohol ethoxylates, alkyl polyglucosides, alkyl phosphates, and mixtures thereof.

Other surfactants include salts of alkyl sulfates, salts of organodisulfonates. Examples of salts of alkyl sulfates include sodium lauryl sulfate, which is available under the tradename Stepanol® Wash. Examples of salts of organodisulfonates include sodium dodecyl diphenyloxide disulfonate, which is available under the tradename Dowfax® 2A1. Other Examples of surfactants include sodium laureth sulfate, Laureth-3 (triethylene glycol dodecyl ether), Laureth-4 (PEG-4 lauryl ether), Laureth-5 (PEG-5 lauryl ether), Laureth-6 (PEG-6 lauryl ether), Laureth-7 (PEG-7 lauryl ether), sodium lauryl ether sulfate, sodium laureth-12 sulfate (PEG (12) lauryl ether sulfate, and sodium laureth-30 sulfate (PEG (30) lauryl ether sulfate).

Yet further examples of surfactants include alkyl aryl sulfonates, a-olefin sulfonates, fatty or rosin acids salts, NPE, alkyl aryl sulfonates, alkyl phenol ethoxylates, fatty acid alcohol ethoxylates, and mixtures of any of the forgoing examples.

Polymerization processes are well known, such as by the semi-continuous process. In general, a first polymer seed latex particles is added to the reactor, either by addition of a pre-formed seed that may be prepared in an independent step (i.e., external seed), or by in situ formation in the reactor for incremental polymerization. A first stream of monomers may be added uniformly over time to the reactor containing the first polymeric seed.

In the incremental polymerization process, the ingredients may be added neat or in combination with deionized water, and in some embodiments, two or more of the ingredients are pre-mixed. Incremental polymerization is begun by combining a first set of one or more polymerizable monomers, surfactant, initiator, chain transfer agent, and optionally chelating agent, to form an aqueous polymerizable emulsion. One or more of the materials may be added over a series of one or more stages. The first set of monomers may be polymerized within the aqueous mixture to form the colloidal particle population.

Regarding the process of making a coated balloon with color and shimmering effects, a curing process may be conducted which may include one or more of the following. Wherein the curing process is curing (“crosslinking”) of unsaturated elastomers via vulcanization. Vulcanization is an irreversible process of linking adjacent polymer chains together, while unsaturated backbone groups and cross linkages contribute to maintaining rubbery- or elasticity properties, elongation and modulus at a given percent elongation. The main curing agents for thermoset rubber include sulfur, accelerators and activators which govern the main parameters of vulcanization, such as temperature and time, as well as the scorch safety of rubber compound manufacturing (premature cure during processing). In addition to the accelerating effect, applying accelerators and activators modify the crosslink density and rate of cure and improve the efficiency of sulfur consumption to form crosslinks, consequently reducing the amount of sulfur in the rubber products. Depending on the chemical structure and influence on the cure rate, accelerators are divided into four classes: slow (guanidines), medium fast (thiazoles and sulfenamides), very fast (thiurams) and ultra-accelerators (dithiocarbamates and xanthates). Some of them, e.g., sulfenamides, provide a delayed action to the vulcanization, ensuring a good balance between the scorch safety and the cure rate. Therefore, regarding the manufacturing of rubber composites and the properties of the final elastomers, thiazoles and sulfenamides are preferable due to the long induction period of the vulcanization and the fast main crosslinking process. Common suitable accelerators include TMTD (tetramethylthiuram disulfide), ZBEC, ZDEC (zinc diethyldithiocarbamate), ZDBC, ZDMC, ZDIBC, ZPDC, and TDEC.

The crosslink structure of sulfur-prevulcanized natural rubber (SPNR) latex which is a useful embodiment to make latex balloons via dipping methods is basically determined by the degree of crosslinking or the crosslink density, as well as the polysulfidity of the crosslinks in the network structure of the elastomer. These, in turn, depend mainly on the sulfur content and sulfur/accelerator ratio in the curing system used. The presence of polysulfidic crosslinks in the elastomer network improves the dynamic fatigue resistance. The best mechanical performance is demonstrated by vulcanizates with long-chain polysulfidic crosslinks in the elastomer network, but with little modification of the main chain of the rubber.

Crude NR latex is stabilized for storage and shipment by the addition of ammonia and/or other stabilizers or cure agents and/or preservatives. A typical stabilized NR latex will contain the following which can be prevulcanized after heating at 60° C. for sufficient time for vulcanization to occur and can be used for dipping or coating as received.

Commercially available stabilized NR latex is available as high ammonia (0.7%) (“HA Latex”), or low ammonia (0.29%) concentrate (“LATZ”). Processing of SPNR latex in enclosed areas may generate odors, therefore low ammonia grades are preferred. In addition to ammonia, stabilized NR latex may be preformulated with vulcanization chemicals such as the above zinc oxide, and zinc diethyl dithiocarbamate and sulfur.

TABLE 2

| LATZ 1 | Weight | | |
|---|---|---|---|
| parts | parts | LATZ 2 | Weight |
| NR latex | 100 | NR Latex | 100 |
| sulfur | 0.8 (I) | ZNO + TMTD | 0.05 |
| zinc diethyl | 0.4 (II) | Ammonia | 0.29 |
| dithiocarbamate | | | |
| zinc oxide | 0.4 (III) | | |
| Ammonia | 0.29 | | |

LATZ1 is made with crude field NR latex stabilized by preparing a water dispersion of about 50 wt. % solid content of I-III above, and then adding this dispersion into the NR latex. Some Field latexes may also be stabilized by a suitable amount of 10% casein solution. In addition, other bases such as potassium hydroxide solution and nonionic surfactant, such as fatty alcohol polyoxyethylene ether (Peregal® 0) can be used. To pre-vulcanize the polymer, the latex compound is heated at 60° C. for 2 hours under continuous stirring, and quickly cooled down with tap water to obtain sulfur-prevulcanized NR latex (SNRL) and after conditioning for three days at ambient temperature is ready for use.

In embodiments, the coated balloon with color and shimmering effects may include the use of one or more dry films having the following properties. It is useful in providing glitter-modified balloons whereby the glitter is firmly adhered such that inflation and handling will not cause significant loss of glitter. It is important to select the type of rubber ink, and latex for adhering the glitter whereby these binders exhibit similar film physical properties, or stress-strain. By matching dry film properties of inks and latexes as nearly as possible to balloons, such as % elongation, tensile strength, and modulus (stiffness at certain % elongation) yields the best result for durable glitter adhesion. A preferred method for bonding glitter to NR balloons is by employing NR based rubber ink, and NR latex which are crosslinked to a similar extent thereby imparting similar stress-strain properties.

This formulation proves effective in creating balloons adorned with glitter, ensuring a secure adhesion that withstands inflation and handling without significant glitter loss. It is crucial to carefully choose the type of rubber ink and latex for affixing the glitter, ensuring these binders possess comparable film properties and stress-strain characteristics. Aligning the dry film properties of the inks and latexes as closely as possible to those of the balloons, considering factors like percentage elongation, tensile strength, and modulus, results in optimal, long-lasting glitter adhesion. A recommended technique for adhering glitter to isoprene balloons involves employing isoprene-based rubber ink and isoprene latex, both crosslinked to a similar degree, thus conferring akin stress-strain properties.

A composition for a glitter film for a balloon may include a rubber ink selected from the group consisting of polyisoprene, styrene-butadiene rubber (SBR), polybutadiene, polyisobutylene, and mixtures thereof. A composition for a glitter film for a balloon may include an emulsion polymer selected from the group consisting of a synthetic latex, a natural latex, and mixtures thereof. A composition for a glitter film for a balloon may include glitter, the glitter is configured to be retained on the balloon when the composition is deposited on the balloon. The preferred type of glitter in the formulation may include polyester-coated aluminum. It should be added in an amount that ensures visibility when sprayed, but not so much that it causes clumping and stacking of glitter. Ideally, the glitter comprises about 5-50% of the total weight of the formulation. In an embodiment, the formulation is most preferably composed of 25% glitter by weight and 75% of the formulation by weight. The glitter is typically composed of small, reflective particles that can be made from various materials, including: Metallic Foils: These are thin sheets of metal, often aluminum or other alloys, that are cut into tiny, reflective particles. Polyethylene Terephthalate (PET) Film: This is a type of plastic that is commonly used in glitter production due to its reflective properties. Polyvinyl Chloride (PVC) Film: PVC can also be used in glitter production, especially in applications where durability is important. Metal, glass and plastic, typically used for craft glitter. Acrylic and Polyester particles, common in cosmetic glitter. Cellulose, sugar and nanocrystals composed plant based materials used in biodegradable glitter.

The glitter flakes may be provided in various shapes such as hexagonal, rectangular, square, or others. Additionally, it is preferred that the glitter flakes may have an effective diameter of approximately 4 mils or less, and a thickness of about 1 mil or less. Metallic pigments may be present in amounts that impart both metallic luster and opacity, without leading to pigment crowding. Gold metallic pigments may be derived from zinc and copper alloys, while silver metallic pigments can be obtained from inhibited aluminum specifically designed for waterborne coatings. In an embodiment, metallic pigments may constitute about 11-18% of the entire formulation. Most preferably, they should be in the range of 11-14% by weight of the entire formulation.

Isoprene rubber, commonly known as polyisoprene, is a synthetic rubber that has a similar chemical structure to natural rubber, which is derived from the latex of certain plants. The chemical composition of isoprene rubber consists primarily of repeating units of the monomer isoprene (2-methyl-1,3-butadiene). The molecular formula of isoprene is C5H8, indicating that it contains five carbon atoms and eight hydrogen atoms per molecule. When polymerized, isoprene molecules join together to form long chains, creating the rubbery material. The basic chemical structure of isoprene rubber can be represented as: (CH₂═C(CH₃)═CH═CH₂) n. This structure shows the repeating unit of isoprene in the polymer chain.

The specific composition of an Isoprene Latex Binder by weight percentage may vary depending on the manufacturer and the intended application. Isoprene Latex: 40%-60%: Isoprene latex serves as the base polymer in the binder. Water: 30%-50%: Water is the primary solvent used to disperse the latex polymer. Emulsifying Agents: 1%-5%: Emulsifying agents stabilize the mixture of water and latex polymer. Stabilizers: 0.5%-2%: Stabilizers are added to prevent coagulation or breakdown of the latex particles. Fillers (Optional): 0%-20%. Fillers or extenders may be added to modify the properties of the binder. Preservatives: <1%. Preservatives prevent microbial growth or spoilage of the binder. Modifiers/Additives: 0.5%-5%. This category includes various additives to enhance performance (e.g., plasticizers, thickeners). Crosslinkers (Optional): <5%: Crosslinking agents, if used, increase the adhesive's resistance to environmental factors. Colorants (Optional): <1%: Colorants are added if a specific color or pigment is desired.

Natural rubber is primarily composed of a polymer called polyisoprene. Its chemical structure consists of repeating units of isoprene, a hydrocarbon molecule. The molecular formula of isoprene is C₅H₈, meaning it has five carbon atoms and eight hydrogen atoms. Synthetic rubber is a man-made material designed to mimic the properties of natural rubber. It is composed of various types of polymers, with one of the most common being styrene-butadiene rubber (SBR). SBR is made from two main monomers: styrene and butadiene. The chemical structure of styrene is C₈H₈, and butadiene has the chemical structure C₄H₆. When polymerized, these monomers form a complex network of repeating units, creating the polymer chain characteristic of rubber materials. Additionally, synthetic rubber may also contain various additives, such as fillers, plasticizers, and curing agents, to enhance its properties and performance for specific applications. Butadiene rubber is also known as polybutadiene, which is a synthetic rubber made from the polymerization of butadiene monomers. Butyl rubber is also known as polyisobutylene and is a synthetic rubber made from the polymerization of isobutylene monomers.

In an embodiment, the glitter-modified balloon composition may include Glitter Particles: 25%. These are the decorative elements that will adhere to the balloons. Binder (Optional): 10%. A binder may be included to help the glitter adhere to the rubber surface. NR Based Rubber Ink: Natural Rubber (NR): 25%. NR serves as the base polymer in the ink. Solvents (e.g., Water): 15%. Solvents are used to disperse the NR polymer. Pigments (Optional): 5%. Pigments provide color to the ink, if desired. Modifiers/Additives: 5%. This category includes various additives to enhance performance (e.g., plasticizers, thickeners). Crosslinkers (Optional): 5%. Crosslinking agents, if used, increase the ink's resistance to environmental factors. Preservatives: <1%. Preservatives prevent microbial growth or spoilage of the ink. NR Latex for Adhesion: Natural Rubber (NR): 20%. Similar to the NR used in the ink, this component provides adhesion. Solvents (e.g., Water): 10%. Solvents serve as the primary medium for dispersing the NR latex. Stabilizers: 5%. Stabilizers are added to prevent coagulation or breakdown of the latex particles. Modifiers/Additives: 5%. This category includes various additives to enhance adhesion properties or desired visual effects. Crosslinkers (Optional): 5%. Crosslinking agents, if used, increase the adhesion's resistance to environmental factors. Preservatives: <1%. Preservatives prevent microbial growth or spoilage of the latex.

In an embodiment the composition may include the following: Latex: Approximately 25% to 90% of the solution is composed of latex, which forms the base material for the balloon. Zinc Oxide (ZnO) and Tetramethylthiuram Disulfide (TMTD): These additives make up about 1% to 10% of the solution. Zinc Oxide is often used in rubber applications for its reinforcing properties, while Tetramethylthiuram Disulfide acts as an accelerator in the vulcanization process. Ammonia: Approximately 1% to 35% of the solution is composed of ammonia, which is likely used for pH adjustment and as a curing agent in the latex processing.

In an embodiment, a technique for positioning an uninflated balloon onto an object, such as a bottle or flask, is employed to hold the balloon open, allowing it to stand upright while being partially filled with air yet remaining somewhat deflated. This serves as a mold to maintain a rounded shape. The latex balloon, still affixed to the mold, is subsequently immersed in a solution of 100% concentrated rubber ink, which has been vigorously mixed by a machine and contains no solvents. Any excess rubber ink is manually wiped away. Following this, the mold, along with the latex balloon, is set into motion, and a precise quantity of glitter is evenly sprinkled over the surface through several rotations, ensuring there are no gaps. The balloon, still attached to the mold, is then misted with a blend of raw, low-ammonia latex and specially treated deionized water. This mixture acts as a polymer to securely adhere the polyester glitter. Finally, the setup is left to cure overnight. This composition ensures that the glitter, NR based rubber ink, and NR latex have similar stress-strain properties due to their crosslinking to a similar extent. The ink provides color and adhesion properties with glitter, while the latex serves as an adhesive to bond the glitter to the balloons. The stabilizers and additives enhance the performance of both the ink and latex.

The low ammonia latex solution may be diluted with deionized water, and this process is quantified in percentages. In an embodiment, a range employed for this purpose spans from about 10% to about 60%. These percentages are adjusted to attain precise adherence levels and visual effects. No other percentage combinations may be utilized for supplementary ingredients. In an embodiment, about 10% to about 60% latex to be mixed with deionized water. In an embodiment, key components necessary for an effective formulation are glitter, liquid latex, and deionized water. While it may be feasible to achieve colored and sparkling balloon coatings without rubber ink, when transitioning from an uninflated to an inflated state, the glitter may not adhere properly and may appear less visually appealing, potentially falling off. Therefore, the use of rubber ink is imperative for optimal glitter adhesion while maintaining a clear view of the balloon's underlying color without any hindrance. Excessive application of rubber ink leads to clumping or dripping. This, combined with the application of glitter, can result in patches of glitter detaching along with the ink, creating uncovered areas. Additionally, an excess of rubber ink adds weight to the balloon, making it less buoyant with helium. Insufficient rubber ink can lead to gaps in glitter coverage, potentially causing patterned effects in the coating. An excess of glitter can cause clumping due to the accumulation of glitter particles, and it can also reduce the balloon's floating time. Conversely, a shortage of glitter results in uneven spots and uncovered areas upon inflation, diminishing the sparkle. Inadequate water content may lead to patterned effects in the coating and variations in color. Conversely, an excess of water can cause the glitter to shed during inflation and handling. An excess of latex makes the balloon too heavy to float and may result in clumping. On the other hand, insufficient latex causes the glitter to fall off during inflation and handling.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications can be referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior present disclosure. Further, the dates of publication provided herein can be different from the actual publication dates, which can require independent confirmation.

The patentable scope of the present disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Insofar as the description above and the accompanying drawing disclose any additional subject matter that is not within the scope of the claims below, the disclosures are not dedicated to the public and the right to file one or more applications to claims such additional disclosures is reserved.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

What is claimed is:

1. A glitter-modified balloon composition, comprising:
a rubber ink selected from the group consisting of polyisoprene, styrene-butadiene rubber (SBR), polybutadiene, polyisobutylene, and mixtures thereof;
an emulsion polymer selected from the group consisting of a synthetic latex, a natural latex, and mixtures thereof; and
glitter, wherein the glitter is configured to be retained on the balloon when the composition is deposited on the balloon.

2. The glitter-modified balloon composition of claim 1, wherein the rubber ink is present in an amount of from about 40% to about 60% by weight of the composition.

3. The glitter-modified balloon composition of claim 1, wherein the rubber ink comprising, by weight:
about 25% natural rubber;
about 15% of a solvent;
about 5% of a pigment;
about 5% of an additive;
about 5% of a crosslinking agent; and
about 1% of a preservative.

4. The glitter-modified balloon composition of claim 3, wherein the pigment has a particle size in a range of from about 0.34 microns to about 34 microns.

5. The glitter-modified balloon composition of claim 1, wherein the emulsion polymer is present in an amount of from about 25% to about 60% by weight of the composition.

6. The glitter-modified balloon composition of claim 1, wherein the natural latex of the emulsion polymer comprising, by weight:
about 20% natural rubber;
about 10% of a solvent;
about 5% of a stabilizer;
about 5% of an additive;
about 5% of a crosslinking agent; and
about 1% of a preservative.

7. The glitter-modified balloon composition of claim 1, wherein the glitter is present in an amount of from about 5% to about 50% by weight of the composition.

8. The glitter-modified balloon composition of claim 1, wherein the glitter comprises a plurality of reflective particles, the glitter selected from the group consisting of metallic foils, polyethylene terephthalate (PET) film, polyvinyl chloride (PVC) film, and mixtures thereof.

9. A formulation, comprising, by weight:
a rubber ink, comprising:
about 40% to about 75% rubber base;
about 5% to about 7% pigment; and
about 5% to about 5% solvent;
a latex binder, comprising:
about 15% to about 65% latex; and
about 0% to about 5% water; and
a reflective material, comprising:
about 1% to about 20% glitter particles.

10. The formulation of claim 9, wherein the rubber ink selected from a vulcanizable synthetic emulsion polymer group consisting of isoprene, butadiene rubber (BR), chloroprene rubber (CR), acrylonitrile-butadiene rubber (NBR), isoprene rubber (IR), styrene-butadiene rubber (SBR), modified styrene-butadiene rubber, carboxy-modified styrene-butadiene rubber (c-SBR), butyl rubber (IIR), and acrylonitrile-styrene-butadiene rubber (NSBR).

11. The formulation of claim 9, wherein the latex binder selected from a vulcanizable synthetic emulsion polymer group consisting of isoprene, butadiene rubber (BR), chloroprene rubber (CR), acrylonitrile-butadiene rubber (NBR), isoprene rubber (IR), styrene-butadiene rubber (SBR), modified styrene-butadiene rubber, carboxy-modified styrene-butadiene rubber (c-SBR), butyl rubber (IIR), and acrylonitrile-styrene-butadiene rubber (NSBR).

12. A latex balloon having a film of glitter particles, comprising:
a latex-based rubber ink, the latex-based rubber ink disposed over the latex balloon;
a plurality of glitter particles, the plurality of glitter particles disposed over the latex-based rubber ink; and
a latex layer, the latex layer disposed over the plurality of glitter particles.

13. The latex balloon having a film of glitter particles of claim 12, wherein the latex layer is a solution of raw low ammonia latex and treated deionized water.

14. The latex balloon having a film of glitter particles of claim 13, wherein the solution comprising, by weight:
about 10% to about 60% latex;
about 25% to about 80% sulfur;
about 15% to about 40% zinc diethyl dithiocarbamate;
about 15% to about 40% zinc oxide;
about 5% to about 29% ammonia; and
about 40% to about 90% deionized water.

15. The latex balloon having a film of glitter particles of claim 13, wherein the solution comprising, by weight:
about 25% to about 90% latex;
about 1% to about 10% Zinc Oxide (ZnO) and Tetramethylthiuram Disulfide (TMTD);
about 1% to about 35% ammonia; and
about 10% to about 80% deionized water.

16. The latex balloon having a film of glitter particles of claim 13, wherein the raw low ammonia latex selected from a vulcanizable synthetic emulsion polymer group consisting of isoprene, butadiene rubber (BR), chloroprene rubber (CR), acrylonitrile-butadiene rubber (NBR), isoprene rubber (IR), styrene-butadiene rubber (SBR), modified styrene-butadiene rubber, carboxy-modified styrene-butadiene rubber (c-SBR), butyl rubber (IIR), and acrylonitrile-styrene-butadiene rubber (NSBR).

17. The latex balloon having a film of glitter particles of claim 13, wherein the plurality of glitter particles are present in an amount of from about 5% to about 30% by weight.

18. The latex balloon having a film of glitter particles of claim 17, wherein the plurality of glitter particles comprises a plurality of reflective particles, the plurality of reflective particles selected from the group consisting of metallic foils, polyethylene terephthalate (PET) film, polyvinyl chloride (PVC) film, and mixtures thereof.

19. A glitter-modified balloon composition, comprising:
a liquid latex;
deionized water; and
glitter, wherein the glitter is configured to be retained on the balloon when the composition is deposited on the balloon.

20. The glitter-modified balloon composition of claim 19, wherein liquid latex is present in an amount of from about 10% to about 60% by weight of the composition.
